(19) United States
(12) Patent Application Publication
(10) Pub. No.: US 2023/0362745 A1
(43) Pub. Date: Nov. 9, 2023

(54) METHODS AND SYSTEMS FOR PERFORMING MOBILITY OPERATIONS IN AN INTEGRATED ACCESS AND BACKHAUL SYSTEM

(71) Applicant: ZTE Corporation, Shenzhen (CN)

(72) Inventors: Ying HUANG, Shenzhen (CN); Lin CHEN, Shenzhen (CN)

(21) Appl. No.: 18/153,572

(22) Filed: Jan. 12, 2023

Related U.S. Application Data
(63) Continuation of application No. PCT/CN2020/105701, filed on Jul. 30, 2020.

(51) Int. Cl. H04W 36/00; H04W 24/08

(52) U.S. Cl. CPC H04W 36/0055; H04W 24/08

(57) ABSTRACT

Methods, apparatus, and systems for determining whether a handover between network nodes should occur, and methods for performing handover. The disclosure relates to mechanisms to for performing mobility in an IAB network by exchanging information, such as mobility configuration information and mobility assistance information, among others.

### CROSS REFERENCE TO RELATED APPLICATIONS

This patent document is a continuation of and claims benefit of priority to International Patent Application No. PCT/CN2020/105701, filed on Jul. 30, 2020. The entire contents of the before-mentioned patent applications are incorporated by reference as part of the disclosure of this application.

### TECHNICAL FIELD

This disclosure is directed generally to wireless communications.

### BACKGROUND

Mobile communication technologies are moving the world toward an increasingly connected and networked society. The rapid growth of mobile communications and advances in technology have led to greater demand for capacity and connectivity. Other aspects, such as energy consumption, device cost, spectral efficiency, and latency are also important to meeting the needs of various communication scenarios. Various techniques, including new ways to provide higher quality of service, longer battery life, and improved performance are being discussed.

### SUMMARY

This patent document describes, among other things, techniques for communicating in an integrated access and backhaul (IAB) deployment for New Radio (NR).

The following aspects may be preferably implemented in various embodiments.

In one aspect, a first integrated and access backhaul (IAB) network node, transmits mobility configuration information to one or more child nodes or one or more wireless devices, and the mobility configuration information is usable for mobility.

In one aspect, a network node receives mobility assistance information from one or more wireless devices, and determines whether to perform migration of the one or more wireless devices. In an aspect, the wireless devices are a UE or an IAB node. In yet another aspect, the mobility configuration information comprises (a) indication information relating to whether a parent node is performing or will perform inter-CU migration, or (b) indication information relating to whether an ancestor node is performing or will perform inter-CU migration, or (c) indication information relating to starting measuring, or (d) measurement configuration. In yet another aspect, the mobility assistance information comprises: (a) measurement results, or (b) a group mobility indication, or (c) a group mobility interest, or (d) a group mobility intention, or (e) a mobility type, or (f) information regarding the target cell, or (g) information regarding the candidate cell. In yet another aspect, the mobility assistance information is received via a Radio Resource Control (RRC) message, or via BAP sublayer, or via MAC sublayer.

In one aspect, the wireless device or a network node transmits mobility assistance information to the IAB donor CU, wherein the mobility assistance information is usable for mobility. In yet another aspect, the mobility assistance information comprises: (a) measurement results, or (b) a group mobility indication, or (c) a group mobility interest, or (d) a group mobility intention, or (e) a mobility type, or (f) information regarding the target cell, or (g) information regarding the candidate cell. In another aspect, the mobility type comprises: a group mobility, or an inter-CU migration, or an inter-DU migration, or an intra-CU migration, or an intra-DU migration.

In an aspect, a network node receives a measurement threshold via a Radio Resource control (RRC) message sent from an IAB donor CU, and performs measurement of the serving cell, wherein if a measured result is lower than the measurement threshold, the network node sends mobility configuration to a child node or a wireless device, or the network node sends mobility assistance information to the IAB donor CU. In yet another aspect, the measurement threshold is a RSRP threshold based on a SS/PBCH block or based on a CSI-RS. In yet another aspect, the mobility configuration information comprises (a) indication information relating to whether the parent network node is performing or will perform inter-CU migration, or (b) indication information relating to whether an ancestor node is performing or will perform inter-CU migration, or (c) indication information relating to starting measuring, or (d) measurement configuration. In yet another aspect, the network node sends the mobility configuration to the child node or the wireless device: (a) via a BAP sub-layer; or (b) via a MAC CE. In yet another aspect, the mobility assistance information comprises: (a) measurement results, or (b) a group mobility indication, or (c) a group mobility interest, or (d) a group mobility intention, or (e) a mobility type, or (f) information regarding the target cell, or (g) information regarding the candidate cell.

In an aspect, the first base station sends a mobility related request message to a second base station, wherein the base station is an eNB or a donor CU or a gNB, receives a mobility related ACK message from the second base station. In yet another aspect, before sending the mobility related message to a second base station, receiving a mobility related required message from a third base station, wherein the base station is a eNB or donor CU or a gNB. In yet another aspect, the mobility related request message is a handover request message, or a SgNB addition request message. In yet another aspect, the mobility related ACK message is a handover request acknowledge message, or a SgNB addition request acknowledge message. In yet another aspect, the mobility related required message is a SgNB change required message. In yet another aspect, the donor CU configures the (a) BH RLC channels, (b) BAP-sublayer routing entries on the target path between the target parent IAB node and target IAB donor DU, or (c) UL traffic mapping for the target path, or (d) DL mappings on the target IAB donor DU. In yet another aspect, the mobility related request or mobility related required message comprises: a group mobility interest, or a group mobility indication, or a mobile IAB node indication, or an IAB node indication, or information relating to a group mobility authorisation, or User Equipment (UE) context information for one or multiple UEs or IAB-MTs, or a BAP address of the IAB node allocated by the source donor CU, or a BH RLC channel configuration for an IAB-MT configured by the source donor CU, or a BH RLC Channel configuration for a collocated IAB-DU configured by the source donor CU including a BH RLC Channel ID or a QoS or a CP traffic type or an RLC mode, or configuration information of collocated IAB-DU, or routing configuration for the collocated IAB-DU configured by the source donor CU, or traffic mapping configuration for a collated IAB-DU configured by the source donor CU, or BAP routing ID and BAP addresses of IAB nodes along a corresponding path configured by the source donor CU, or a Path ID and BAP addresses of IAB nodes along the corresponding path configured by the source donor CU, or a gNB-DU UE F1AP ID, or a PDCP information, or an identity of DU which serves the UE/IAB-MT including its BAP address, or its DU ID, and/or the gNB ID of source donor CU.

In yet another aspect, the configuration information of collocated IAB-DU comprises: an IP address request information including an IP address request or an IPV4 address request number or an IPv6 address request number or an IPv6 prefix request, or a DU ID, or updated DU served cell information including a PCI or a CGI or a PLMN ID list. In yet another aspect, the mobility related ACK message comprises: a group mobility indication, or RRCreconfiguration message(s) for one or multiple UEs or IAB-MTs, or a collocated IAB-DU configuration information, or a routing configuration information configured by the second base station, or a traffic mapping configuration information configured by the second base station, or a indication information which indicates that the routing configuration information or the traffic mapping configuration information is applicable on the target path. In yet another aspect, the collocated IAB-DU configuration information comprises: IP address information allocated for the IAB-DU comprising an IP address, or an IP address prefix, or an IP address usage, or an IAB donor DU BAP address, or the target donor CU’s IP address, or reconfigured DU ID for the collocated IAB-DU, or updated DU Served Cell information, including a PCI or a CGI or a PLMN ID list.

In yet another aspect, after receiving the mobility related message from a first base station, receiving, at the second base station, a F1 setup request message from a IAB node, wherein the F1AP message includes gNB ID of source donor CU.

In yet another aspect, after receiving the mobility related message from the first base station, sending, at the second base station, a F1AP message to a IAB node, wherein the message includes multiple gNB-DU UE F1AP IDs, or UL UP TNL Information, or New UL UP TNL Information, or BH Information, or Old TNL Address of gNB-CU, or New TNL Address of gNB-CU, or a source F1AP UE context release indication, or a CU change indication, or a inter donor migration indication, wherein the F1AP message is a UE context setup request message, or a UE context modification request message, or a IAB UP configuration update request message, or a new F1AP message. In yet another aspect, after sending the mobility related ACK message to the first base station, sending, at the second base station, a UE context release message to the first base station, wherein the UE context release message includes multiple pairs of source/target NG-RAN node UE XnAP IDs, or multiple pairs of old and new eNB UE X2AP IDs. In yet another aspect, after receiving the mobility related ACK message from the second base station, sending, at the first base station, a message to the second base station, wherein the message includes SN status information for multiple UEs/IAB-MTs, or multiple pairs of source and/or target NG-RAN node UE XnAP IDs, or multiple pairs of old and new eNB UE X2AP IDs.

In an aspect, receiving, at a target network node, PDCP information, performing, at the target network node, (a) deciphering using the received PDCP information, or (b) header decompression using the received PDC information, or (c) integrity verification using the received PDCP information. In yet another aspect, before receiving the PDCP information, transmitting, at the target network node, PDCP configuration request information to the source network node, wherein the PDCP configuration request information includes a PDCP key request indication or a PDCP key indication. In yet another aspect, the PDCP information includes ciphering related info, or integrity related info, or a Hyper Frame Number (HFN), or Header Compression related information. In yet another aspect, the network node is a donor CU or an IAB node. In yet another aspect, the wireless device is a User Equipment (UE) and the child node is an IAB node. In yet another aspect, the network node is a donor CU.

In aspects of the disclosure, the transmission and reception of messages is performed by various devices, including MT, UE, IAB nodes (e.g., access, migrating, descendant, or ancestor), and IAB donors.

These, and other, aspects are described in the present disclosure.

### BRIEF DESCRIPTION OF DRAWINGS

FIG. 1 illustrates an embodiment of an IAB deployment in a moveable vehicle.

FIG. 2 illustrates an embodiment of an IAB topology.

FIG. 3 illustrates an IAB topology where handover of an IAB node is performed.

FIG. 4 illustrates an embodiment where mobility configuration is transmitted

FIG. 5 illustrates an embodiment where mobility assistance information is transmitted.

FIG. 6 illustrates an embodiment where the node transmits mobility assistance information.

FIG. 7 illustrates a mobility decision based on a measurement threshold.

FIG. 8 illustrates a handover method.

FIG. 9 Illustrates a handover procedure.

FIG. 10 illustrates sending PDCP information used in transmitting packets.

FIG. 11 illustrates an eNB that is connected to a migrating IAB node.

FIG. 12 illustrates the migration of a topology.

FIG. 13 illustrates the migration of a topology.

FIG. 14 shows an example of a wireless communication system where techniques in accordance with one or more embodiments of the present technology can be applied.

FIG. 15 is a block diagram representation of a portion of a radio station in accordance with one or more embodiments of the present technology can be applied.

### DETAILED DESCRIPTION

The disclosure relates to wireless systems. More specifically, it relates to reducing packet loss during handover in a IAB deployment.

For instance, an integrated access and backhaul (IAB) system supports wireless backhauling by deploying new radio (NR) cells to reduce the need for wireline transport infrastructure.

The terminating node of the NR backhaul network on the network side is commonly referred to as an IAB donor, which represents a gNB, which is the logical node that has additional functionality to support IAB. An IAB node supports gNB Distributed Unit (gNB-DU) functionality, which allows NR access to user equipment (UE) and next-hop IAB nodes. The IAB node also supports functionality for IAB-MT, which allows connections to the gNB-DU of another IAB node or the IAB donor.

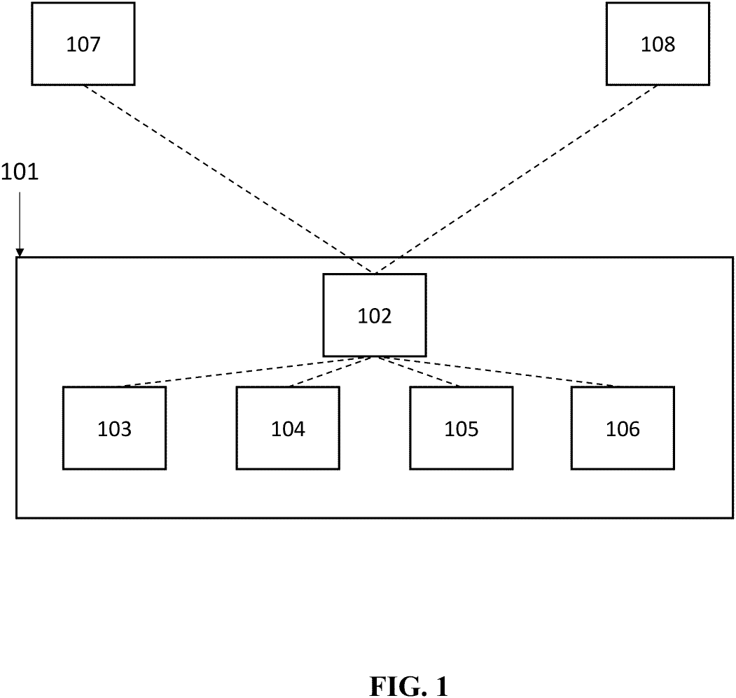

In one example, as shown in FIG. 1, a moveable vehicle, such as a high speed train 101 has several passengers with one or more mobile terminal (MT) or user equipment (UE) 103-106. The UE 103-106 are wirelessly connected to an IAB node 102, and the IAB node 102 is in turn connected to a donor node or a parent IAB node 107 or 108. As the high speed train moves, handover between parent IAB nodes occurs. The UE 103-106 accesses the network via the IAB node 102, and the IAB node 102 accesses the network via a parent IAB node. Here, it should be understood that the usage of UE and MT are not mutually exclusive, and one should presume that either term can refer to either a MT or UE. It should also be understood that a parent IAB node should be understood to be encompassed by the term base station. It should be understood that, although a moveable vehicle has been discussed, the techniques disclosed herein are also applicable to static IAB nodes, which may want to perform migration due to load balance or due to Back Haul Radio Link Failure (BH RLF).

The relative positions between the UEs 103-106 and the IAB node 102 will change little as the train 101 travels across. However, the relative position between the IAB node 102 and each IAB donor will change frequently when the train 101 travels.

Consequently, this disclosure provides systems and methods performing handover of the IAB node 102 can be performed. This reduces signaling overhead and improves service continuity.

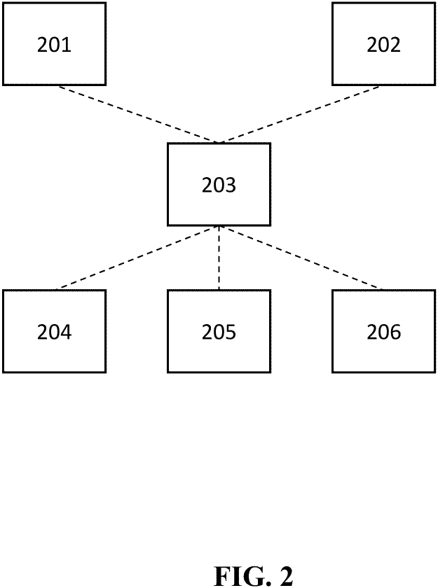

FIG. 2 illustrates an IAB topology. Parent nodes 201 and 202 have IAB-DU functionality, and they provide NR access to an IAB node 203. IAB node 203 has functionality as both an IAB MT and as an IAB DU. IAB node 203 can connect to parent nodes 201 and 202 as a IAB MT, and also provide access to child nodes 204-206 as a IAB DU. Child nodes 204-206 have functionality of an IAB MT. As can be understood, any node in the topology can work as a donor or a terminal, so long as it is designed with that functionality.

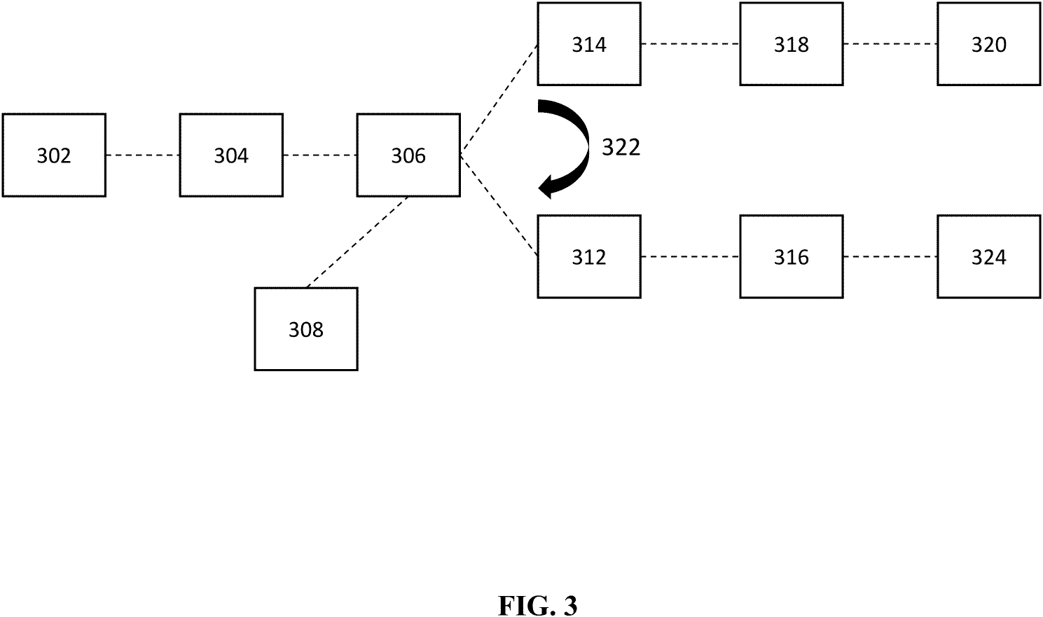

FIG. 3 illustrates an IAB topology where handover of an IAB node is performed.

UE 302 is wirelessly coupled to an IAB node 304, which is wirelessly coupled to IAB node 306. A UE 308 is coupled to IAB node 306. It should be understood that any number of UE or MT can be coupled to any of the IAB nodes.

As denoted from arrow 322, IAB node 306 is migrating from IAB node 314 to IAB node 312. IAB node 314 is coupled to IAB donor DU 318, and IAB node 312 is coupled to IAB donor DU 324. Both IAB donor 318 and 316 are coupled to different IAB donor CUs. In the case of FIG. 3, the IAB node 306 not only migrates between IAB nodes, but also between IAB donor CUs.

It should be understood that the topologies disclosed are only exemplary. Any number of nodes, UEs, or donors can exist within an IAB deployment.

The topologies disclosed apply to the embodiments disclosed herein.

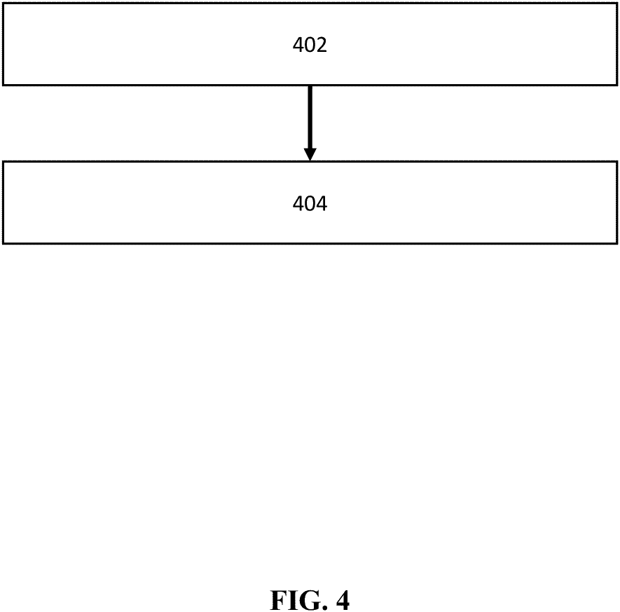

FIG. 4 illustrates an embodiment where mobility configuration is transmitted. At step 402, an IAB node transmits configuration information to an IAB child node or UE. At step 404, the IAB child node or UE uses the mobility configuration information for mobility. In an embodiment, the mobility configuration information comprises (a) indication information relating to whether a parent node is performing or will perform inter-CU migration, or (b) indication information relating to whether an ancestor node is performing or will perform inter-CU migration, or (c) indication information relating to starting measuring, or (d) measurement configuration.

In an embodiment, a CU sends mobility configuration information to the IAB MT/UE. The mobility configuration information includes at least one of the following: (a) indication information relating to whether a parent node is performing or will perform inter-CU migration, or (b) indication information relating to whether an ancestor node is performing or will perform inter-CU migration, or (c) indication information relating to starting measuring, or (d) measurement configuration

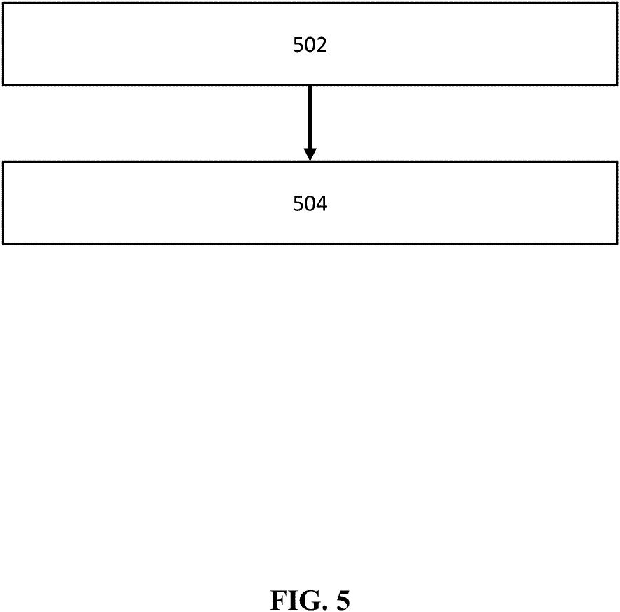

FIG. 5 illustrates an embodiment where mobility assistance information is transmitted. In step 502, a network node receives mobility assistance information from a wireless device or a IAB node. And the network node could be a IAB donor CU or a IAB node. In an embodiment, in step 504, the network node determines whether to perform migration of the wireless device. In an embodiment, the mobility assistance information comprises: (a) measurement results, or (b) a group mobility indication, or (c) a group mobility interest, or (d) a group mobility intention, or (e) a group mobility interest, or (f) a group mobility intention, or (g) a mobility type, or (h) information regarding the target cell, or (i) information regarding the candidate cell. In another embodiment, the mobility assistance information is received via a Radio Resource Control (RRC) message, or via BAP sublayer, or via MAC sublayer.

In an embodiment, the UE/IAB-MT sends mobility assistance information to the donor CU. The mobility assistance information includes at least one of the following: Measurement results, Group mobility indication/interest/intention, mobility type, a group mobility interest, a group mobility intention, target cell information, or candidate cell information. UE/IAB MT could send mobility assistance information to donor CU via RRC message, e.g. RRCSetupRequest, RRCSetupComplete, RRCReestablishmentComplete, RRCReestablishmentRequest, RRCResumeRequest, RRCResumeComplete, UEAssistanceInformation, measurementreport message. In an embodiment, the Source donor CU determines whether to perform mobility procedure for the corresponding UE/IAB MT.

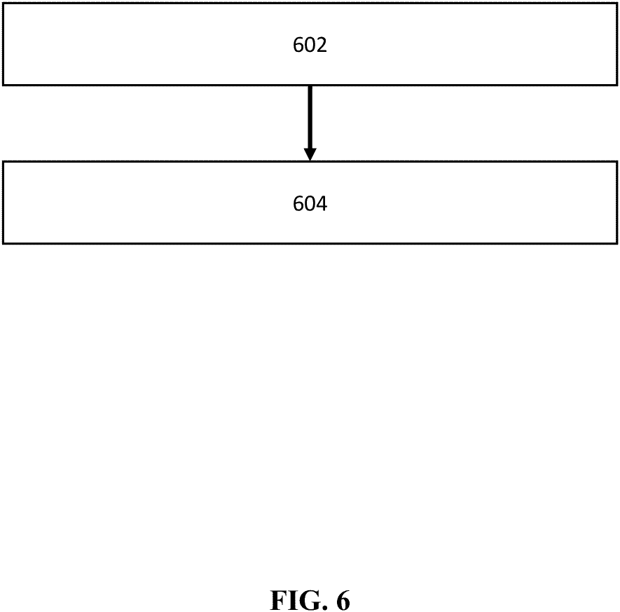

FIG. 6 illustrates an embodiment where the IAB node or UE transmits mobility assistance information. In step 602, mobility assistance information is transmitted to the IAB donor CU. In step 604, mobility assistance information is used for handover. In an embodiment, the mobility assistance information comprises: (a) measurement results, or (b) a group mobility indication, or (c) a group mobility interest, or (d) a group mobility intention, or (e) a group mobility interest, or (f) a group mobility intention, or (g) a mobility type, or (h) information regarding the target cell, or (i) information regarding the candidate cell. In an embodiment, the mobility type comprises: a group mobility, or an inter-CU migration, or an inter-DU migration, or an intra-CU migration, or an intra-DU migration.

In an embodiment, UE/IAB node may optionally first receive mobility configuration information from IAB donor or parent IAB node. The mobility configuration information includes at least one of the following: (a) indication information relating to whether a parent node is performing or will perform inter-CU migration, or (b) indication information relating to whether an ancestor node is performing or will perform inter-CU migration, or (c) indication information relating to starting measuring, or (d) measurement configuration. After, the UE/IAB node determines whether to perform mobility, or the UE/IAB node determines the mobility type, e.g. group mobility, inter-CU migration, inter-DU migration, intra-CU migration, intra-DU migration; or UE/IAB node determines the target cell; or UE/IAB node determines the candidate cells. Thereafter, the UE/IAB node sends mobility assistance information to donor CU. The mobility assistance information includes at least one of the following: Measurement results, Group mobility indication/interest/intention, a group mobility interest, a group mobility intention, mobility type, target cell information, or candidate cell information.

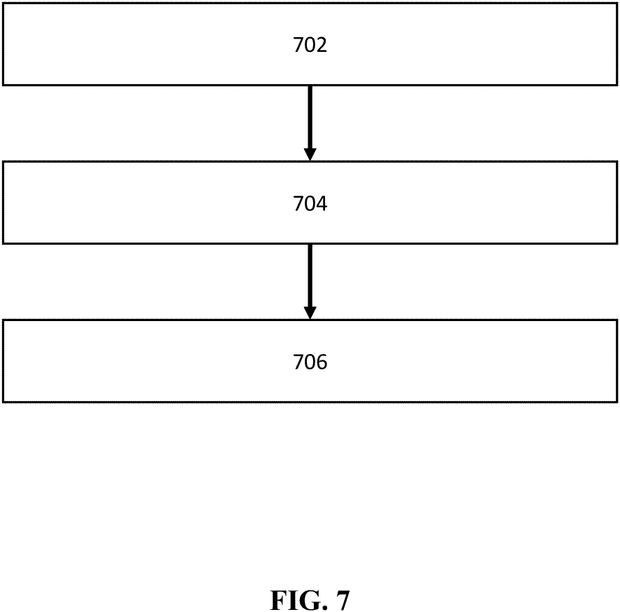

FIG. 7 illustrates a mobility decision based on a measurement threshold. In step 702, a measurement threshold is received via a Radio Resource control (RRC) message sent from an IAB donor CU. In step 704, measurement of the serving cell is performed. In step 706, the network node sends mobility configuration to the network node if the result is lower than the threshold. In an embodiment, the measurement threshold is a RSRP threshold based on a SS/PBCH block or based on a CSI-RS. In an embodiment, the mobility configuration information comprises (a) indication information relating to whether the parent network node is performing or will perform inter-CU migration, or (b) indication information relating to whether an ancestor node is performing or will perform inter-CU migration, or (c) indication information relating to starting measuring, or (d) measurement configuration. In another embodiment, the mobility configuration is sent (a) via a BAP sub-layer; or (b) via a MAC CE. In an embodiment, the mobility assistance information comprises: (a) measurement results, or (b) a group mobility indication, or (c) a group mobility interest, or (d) a group mobility intention, or (e) a group mobility interest, or (f) a group mobility intention, or (g) a mobility type, or (h) information regarding the target cell, or (i) information regarding the candidate cell.

In an embodiment, a donor CU sends measurement threshold to IAB node via RRC. For example, the measurement threshold could be a RSRP threshold based on SS/PBCH block or based on CSI-RS. The IAB node performs measurement of the serving cell and, when the measured RSRP is lower than the measurement threshold, the IAB node sends mobility configuration information to child IAB node/UE. Optionally, when IAB node receives mobility configuration information from parent node, it can send mobility configuration information to its child node. In an embodiment, the mobility configuration information includes at least one of the following: (a) indication information relating to whether a parent node is performing or will perform inter-CU migration, or (b) indication information relating to whether an ancestor node is performing or will perform inter-CU migration, or (c) indication information relating to starting measuring, or (d) measurement configuration. In an embodiment, the IAB node could send mobility configuration information to child IAB nod/UE using one of the following methods: (1) IAB node sends mobility configuration information to child IAB node via BAP sublayer, e.g. via BAP control PDU or (2) IAB node sends mobility configuration information to child IAB node/UE via MAC CE. In an embodiment, the IAB node could send mobility assistance information to donor CU. And then donor CU sends mobility configuration information to child IAB node/UE via RRC. In an embodiment, the mobility assistance information includes at least one of the following: Measurement results or Group mobility indication/interest/intention or a group mobility interest or a group mobility intention or mobility type or target cell information or candidate cell information. In an embodiment, the child IAB MT or UE performs measurement on serving cell and/or non-serving cells. Optionally, child IAB MT or UE sends mobility assistance information to the donor CU.

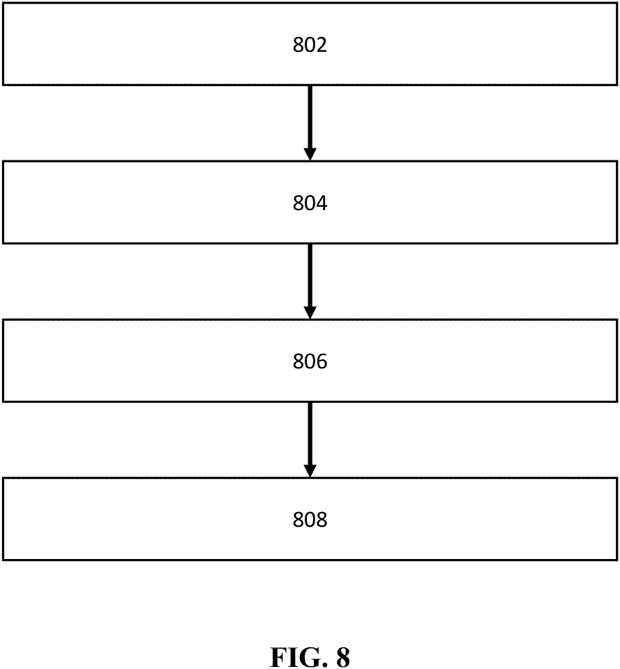

FIG. 8 illustrates a handover method. In step 802, a base station transmits a mobility related request message to a second base station, where the base station is an eNB or a donor CU or a gNB. In step 804, the base station receives a mobility related ACK message from the second base station. Optionally, prior to step 802, the base station can receive a mobility related required message from a third base station, wherein the base station is a eNB or donor CU or a gNB. In an embodiment, the mobility related request message is a handover request message, or a SgNB addition request message. In an embodiment, the mobility related ACK message is a handover request acknowledge message, or a SgNB addition request acknowledge message. In another embodiment, the mobility related required message is a SgNB change required message.

In an embodiment, the mobility related request or mobility related required message comprises: a group mobility interest, or a group mobility indication, or a mobile IAB node indication, or an IAB node indication, or information relating to a group mobility authorisation, or User Equipment (UE) context information for one or multiple UEs or IAB-MTs, or a BAP address of the IAB node allocated by the source donor CU, or a BH RLC channel configuration for an IAB-MT configured by the source donor CU, or a BH RLC Channel configuration for a collocated IAB-DU configured by the source donor CU including a BH RLC Channel ID or a QoS or a CP traffic type or an RLC mode, or configuration information of collocated IAB-DU, or routing configuration for the collocated IAB-DU configured by the source donor CU, or traffic mapping configuration for the collated IAB-DU configured by the source donor CU, or BAP routing ID and BAP addresses of IAB nodes along the corresponding path configured by the source donor CU, or a Path ID and BAP addresses of IAB nodes along the corresponding path configured by the source donor CU, or a gNB-DU UE F1AP ID, or a PDCP information, or an identity of DU which serves the UE/IAB-MT including its BAP address, or its DU ID, and/or the gNB ID of source donor CU. In an embodiment, the configuration information of collocated IAB-DU comprises: an IP address request information including an IP address request or an IPV4 address request number or an IPv6 address request number or an IPv6 prefix request, or a DU ID, or updated DU served cell information including a PCI or a CGI or a PLMN ID list. In an embodiment, the mobility related ACK message comprises: a group mobility indication, or RRCreconfiguration message(s) for one or multiple UEs or IAB-MTs, or a collocated IAB-DU configuration information, or a routing configuration information configured by the second base station, or a traffic mapping configuration information configured by the second base station, or a indication information which indicates that the routing configuration information or the traffic mapping configuration information is applicable on the target path.

In yet another embodiment, wherein the collocated IAB-DU configuration information comprises: IP address information allocated for the IAB-DU comprising an IP address, or an IP address prefix, or an IP address usage, or an IAB donor DU BAP address, or the target donor CU’s IP address, or reconfigured DU ID for the collocated IAB-DU, or updated DU Served Cell information, including a PCI or a CGI or a PLMN ID list. In yet another embodiment,

In step 806, the donor CU configures (a) BH RLC channels, (b) BAP-sublayer routing entries on the target path between the target parent IAB node and target IAB donor DU, (c) UL traffic mapping for the target path, or (d) DL mappings on the target IAB donor DU.

In step 808, after receiving the mobility related message from a second base station receives a F1 setup request message from the IAB node, wherein the F1 setup message includes gNB ID of source IAB donor CU.

In yet another embodiment, after receiving the mobility related message from the first base station the second base station sends an F1AP message to a IAB node, wherein the message includes multiple gNB-DU UE F1AP IDs, or UL UP TNL Information, or New UL UP TNL Information, or BH Information, or Old TNL Address of gNB-CU, or New TNL Address of gNB-CU, or a source F1AP UE context release indication, or a CU change indication, or a inter donor migration indication, wherein the F1AP message is a UE context setup request message, or a UE context modification request message, or a IAB UP configuration update request message, or a new F1AP message. In yet another embodiment, after sending the mobility related ACK message to the first base station, sending a UE context release message is sent to the first base station, wherein the UE context release message includes multiple pairs of source/target NG-RAN node UE XnAP IDs, or multiple pairs of old and new eNB UE X2AP IDs. In yet another embodiment, after receiving the mobility related ACK message from the second base station, sending, at the first base station, a message to the second base station, wherein the message includes SN status information for multiple UEs/IAB-MTs, or multiple pairs of source and/or target NG-RAN node UE XnAP IDs, or multiple pairs of old and new eNB UE X2AP IDs. In yet another embodiment, after receiving the mobility related ACK message from the second base station, sending, at the first base station, a message to the third base station, wherein the message includes SgNB change confirm for multiple UEs/IAB-MTs, or multiple pairs of MeNB UE X2AP ID and SgNB UE X2AP ID. In yet another embodiment, after receiving the mobility related ACK message from the second base station, sending, at the first base station, a mobility related release message to the third base station, wherein the mobility related release message includes SgNB release request information for multiple UEs/IAB-MTs, or multiple pairs of MeNB UE X2AP ID and SgNB UE X2AP ID. In yet another embodiment, after receiving the mobility related release message from the first base station, sending, at the third base station, a message to the first base station, wherein the message includes SgNB release request acknowledge information for multiple UEs/IAB-MTs, or multiple pairs of MeNB UE X2AP ID and SgNB UE X2AP ID. The SgNB addition request ACK message is sent from target donor CU to eNB.

It should be understood that the steps described herein are exemplary, and any one method step is not required, or required to be excluded. Further, it should be understood that, unless otherwise explicitly stated as being necessary, each step is not required for the full mobility procedure.

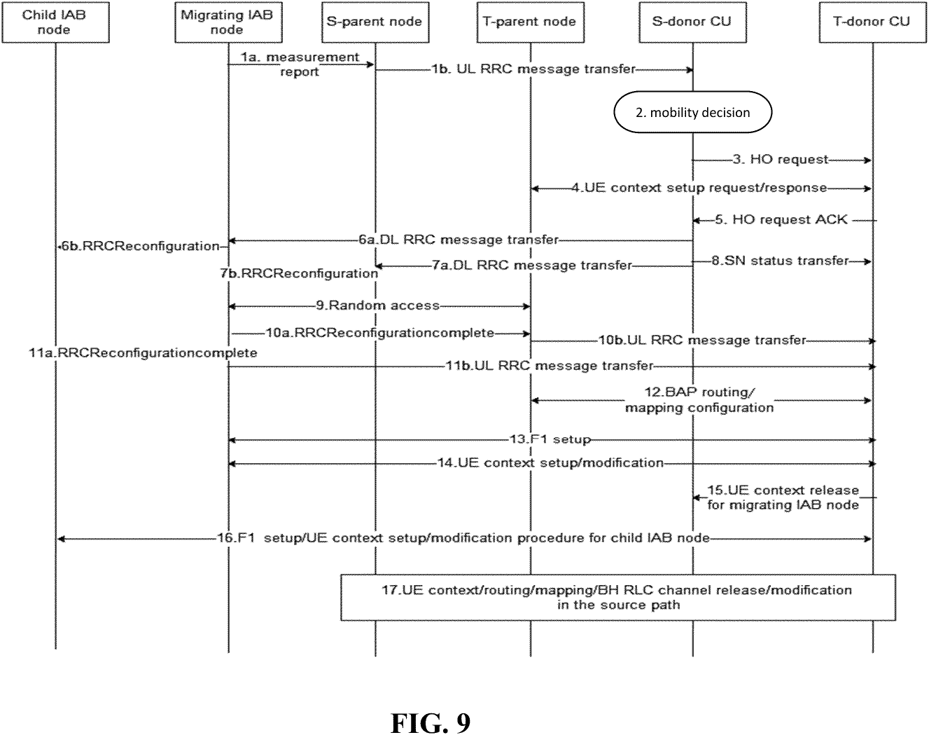

FIG. 9 Illustrates a handover procedure. Step 1a-1b are optional, where the migrating IAB node performs measurement and sends measurement report to the source donor CU. In an embodiment, the measurement report is included in UL RRC message transfer and sent from source parent node to source donor CU.

Step 2 is optional. Here, source donor CU performs mobility decision. The mobility decisions described herein could be applied.

In Step 3, the source donor CU sends a handover request message to the target donor CU. In an embodiment, the handover request message includes at least one of the following: (a) group mobility interest, or group mobility indication, or mobile IAB node indication, or IAB node indication, or group mobility authorized information; or (b) UE context information for multiple UEs or IAB-MTs; or (c) BAP address of IAB node allocated by source donor CU; or (d) BH RLC channel configuration for IAB-MT configured by source donor CU; or (e) BH RLC channel configuration for collocated IAB-DU configured by source donor CU, including one of following: (i) BH RLC channel ID, QoS, CP traffic type, RLC mode, etc., or (ii) configuration information of collocated IAB-DU, including one of the following: IP address request information, including one of the following IP address request, IPv4 address request number, IPv6 address request number, or IPv6 address prefix request, etc., or (iii) DU ID, or (iv) updated DU Served Cell information, including PCI, CGI, PLMN ID list, etc., or (f) Routing configuration for the collocated IAB-DU configured by source donor CU, or (g) Traffic mapping configuration for the collocated IAB-DU configured by source donor CU, or (f) BAP routing ID and BAP addresses of IAB nodes along the corresponding path configured by source donor CU, or (g) Path ID and BAP addresses of IAB nodes along the corresponding path configured by source donor CU, or (h) gNB-DU UE F1AP ID, or (i) identity of DU which serves the UE/IAB-MT, e.g. BAP address, DU ID and/or gNB ID of source donor CU.

In Step 4, the target donor CU initiates UE context setup procedure with target parent node. Target parent node sends UE context setup response after receiving UE context setup request message.

In Step 5, the target donor CU sends handover request ACK message to source donor CU. The handover request ACKNOWLEDGE message includes at least one of the following: (1) group mobility indication, or (2) HandoverCommand messages for multiple UEs or IAB-MTs, or (3) Collocated IAB-DU configuration info, including one of the following: (a) IP address information allocated for IAB-DU, including one of the following: IP address, IP address prefix, IP address usage, IAB donor DU BAP address, or (b) Target donor CU’s IP address, or (c) Reconfigured DU ID for the collocated IAB-DU, or (d) updated DU Served Cell information, including PCI, CGI, PLMN ID list, etc.

In Steps 6 and 7, source donor CU sends a handover command message to migrating IAB’s descendant IAB node and UEs and migrating IAB node. The handover command message is included in DL RRC message transfer message and sent from source donor CU to IAB-DU.

In Step 8, the source donor CU sends SN status transfer message to target donor CU. The SN status transfer message may include SN status information for multiple UEs/IAB-MTs. The SN status transfer message may include one or multiple pairs of source/target NG-RAN node UE XnAP IDs, or multiple pairs of old and new eNB UE X2AP IDs.

In Step 9, the migrating IAB node performs random access with target parent node.

In Steps 10-11, after receiving RRCReconfiguration message, UE/IAB node sends RRCReconfigurationcomplete message to target donor CU. The RRCReconfigurationcomplete message is included in UL RRC message transfer message and sent from access IAB node to target donor CU.

In Step 12, the target donor CU configures at least one of the BH RLC channels or BAP-sublayer routing entries on the target path between the target parent IAB-node and target IAB-donor-DU or UL traffic mapping for the target path or DL mappings on the target IAB-donor-DU. These configurations may be performed at an earlier stage, e.g. immediately after step 5.

In Step 13, migrating IAB node initiates F1 setup procedure with the target donor CU using the IP address received via RRC. Migrating IAB node sends F1 setup request message to target donor CU. Optionally, F1 setup request message includes gNB ID of source IAB donor.

In Step 14a, the target donor CU sends UE context setup request message to migrating IAB node. UE context setup request message includes one or multiple gNB-DU UE F1AP IDs. And then migrating IAB node sends F1AP UE context setup response message to target donor CU. Optionally, UE context setup request message includes indication info. The indication info includes at least one of the following: (a) source F1AP UE context release indication, or (b) CU change indication, or (c) Inter donor migration indication. In an embodiment, the migrating IAB node may release corresponding UE context associated with source donor CU after receiving the indication info.

Step 14b may be performed instead of Step 14a. In Step 14b, the target donor CU sends UE context modification request message to migrating IAB node. In an embodiment, the UE context modification request message includes one or multiple gNB-DU UE F1AP IDs. After, the migrating IAB node sends F1AP UE context modification response message to target donor CU. In an embodiment, the UE context modification request message includes indication info. The indication info includes at least one of the following: (a) source F1AP UE context release indication, or (b) CU change indication, (c) inter donor migration indication.

In Step 15, the target donor CU sends UE context release message to source donor CU. UE context release message includes one or multiple pairs of source/target NG-RAN node UE XnAP IDs, or multiple pairs of old and new eNB UE X2AP IDs. Step 15 is optional.

In Step 16, a F1 setup procedure is performed for migrating IAB node’s descendant node, and UE context setup or modification procedure is performed for migrating IAB node’s descendant node.

In Step 17, UE/migrating IAB node/child IAB node’s UE context in the source donor CU is released. And routing/traffic mapping/BH RLC channel configurations are released or reconfigured in the source path.

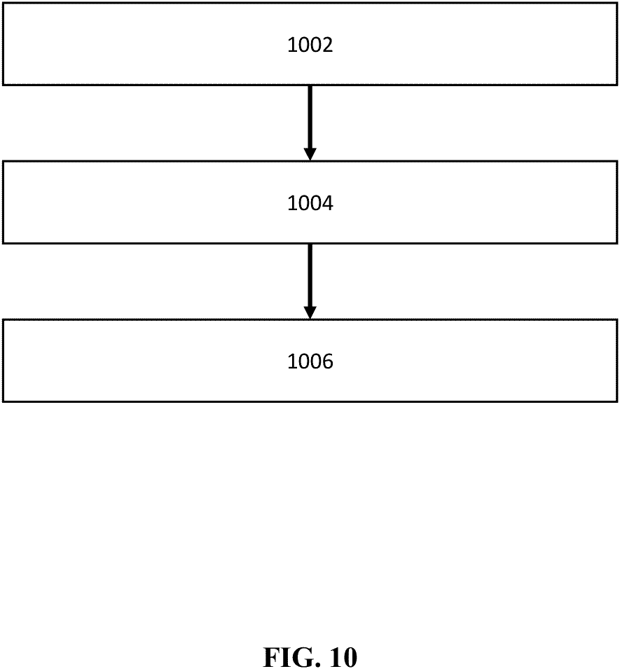

FIG. 10 illustrates sending PDCP information used in transmitting packets. In Step 1002, optionally, before receiving the PDCP information, PDCP configuration request information is transmitted to the source network node, wherein the PDCP configuration request information includes a PDCP key request indication or a PDCP key indication. In Step 1004, a network node receives PDCP information. In Step 1006, the network node uses that PDCP information to decipher, perform header decompression, or perform integrity verification. In an embodiment, the PDCP information includes ciphering related info, or integrity related info, or a Hyper Frame Number (HFN), or Header Compression related information.

In yet another embodiment, the target donor CU sends routing/traffic mapping configuration of target path to IAB node during handover preparation phase, and the routing/traffic mapping configuration info of target path is contained in the HO CMD message, including routing configuration/F1-U traffic mapping info. In an embodiment, the routing/traffic mapping configuration info of target path is contained in the HO request ACKNOWLEDGE message, and the source donor CU sends the routing/traffic mapping configuration to IAB node via F1AP message. In yet another embodiment, an indication is included along with the updated routing/traffic mapping configuration to indicate that it is applied on the target path.

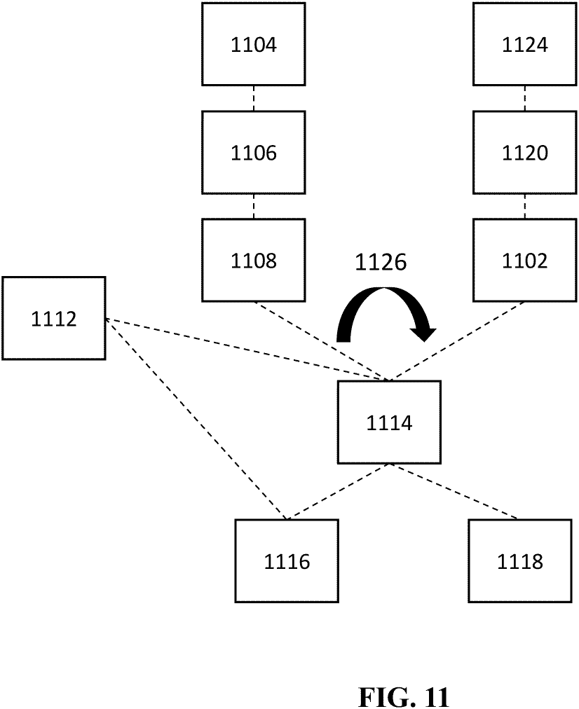

FIG. 11 illustrates an eNB that is connected to a migrating IAB node. eNB 1112 is connected to a migrating IAB node 1114, which itself is connected to UE 1116 and child IAB node 1118. Migrating IAB node 1114 is migrating from: (a) IAB node 1108 connected to IAB donor DU 1106, connected to IAB donor CU 1104 to (b) IAB node 1102 connected to IAB donor DU 1120, connected to IAB donor CU 1124. The migration is illustrated with arrow 1126.

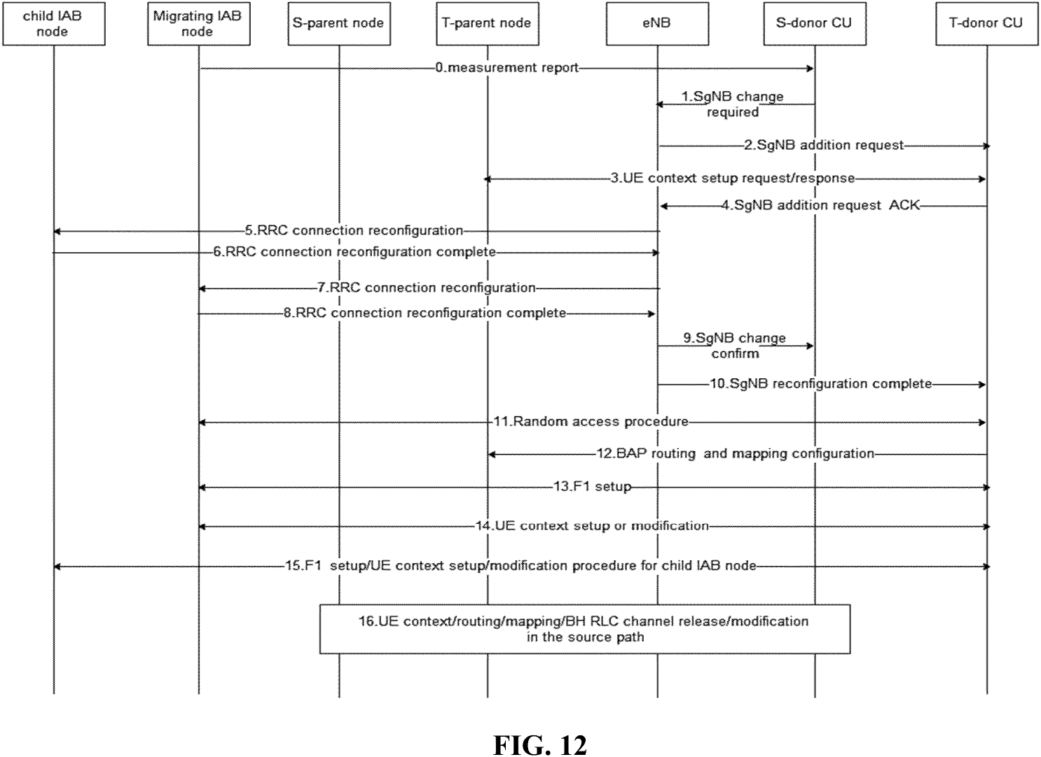

FIG. 12 illustrates the migration of a topology like one illustrated in FIG. 11.

Step 0 is optional. In Step 0, the migrating IAB node sends measurement report to the eNB or source donor CU

In Step 1, the source donor CU initiates the SN change procedure by sending SgNB Change Required message to the eNB. In an embodiment, the SgNB Change Required message includes at least one of the following: (a) group mobility interest, or group mobility indication, or mobile IAB node indication, or IAB node indication, or group mobility authorized information, or (b) UE context information for multiple UEs or IAB-MTs, or (c) BAP address of IAB node allocated by source donor CU, or (d) BH RLC channel configuration for IAB-MT configured by source donor CU, or (e) BH RLC channel configuration for collocated IAB-DU configured by source donor CU, including one of following: BH RLC channel ID, QoS, CP traffic type, RLC mode, etc., or (f) configuration information of collocated IAB-DU, including one of the following: (i) IP address request information, including one of the following IP address request, IPv4 address request number, IPv6 address request number, IPv6 address prefix request, etc., or (ii) DU ID, or (iii) updated DU Served Cell information, including PCI, CGI, PLMN ID list, etc., or (g) Routing configuration for the collocated IAB-DU configured by source donor CU, or (h) traffic mapping configuration for the collocated IAB-DU configured by source donor CU, or (i) BAP routing ID and BAP addresses of IAB nodes along the corresponding path configured by source donor CU, or (j) path ID and BAP addresses of IAB nodes along the corresponding path configured by source donor CU, or (k) gNB-DU UE F1AP ID, or (1) identity of DU which serves the UE/IAB-MT, e.g. BAP address, DU ID and/or gNB ID of source donor CU.

In step 2, the eNB sends SgNB addition request message to the target donor CU.

In Step 3, the target donor CU initiates UE context setup procedure with target parent node. Target parent node sends UE context setup response after receiving UE context setup request message.

In Step 4, the target donor CU sends SgNB addition request ACK message to the eNB. The SgNB addition request ACK message includes at least one of the following: (a)group mobility indication, or (b) RRC reconfiguration messages for multiple UEs or IAB-MTs, or (c) Collocated IAB-DU configuration info, including one of the following: (i) IP address information allocated for IAB-DU, including one of the following: IP address, IP address prefix, IP address usage, IAB donor DU BAP address, (ii) target donor CU’s IP address, (iii) reconfigured DU ID for the collocated IAB-DU, or (iv) updated DU Served Cell information, including PCI, CGI, PLMN ID list, etc.

In Steps 5-8, the eNB sends RRC connection reconfiguration message including the new configuration to child/migrating IAB nodes and UEs. The IAB node or UE applies the new configuration and sends the RRCConnectionReconfigurationComplete message to the eNB

In Step 9, the eNB sends SgNB change confirm message to the source donor CU.

In Step 10, if the RRC connection reconfiguration procedure was successful, the eNB informs the target donor CU via SgNB Reconfiguration Complete message.

In Step 11, migrating IAB nodes performs random access procedure with the target parent node or target donor CU.

In Step 12, target donor CU configures at least one of the BH RLC channels or BAP-sublayer routing entries on the target path between the target parent IAB-node and target IAB-donor-DU or UL traffic mapping for the target path or DL mappings on the target IAB-donor-DU. These configurations may be performed at an earlier stage, e.g. immediately after step 4.

In Step 13, the migrating IAB node initiates F1 setup procedure with the target donor CU using the IP address received via RRC. Migrating IAB node sends F1 setup request message to target donor CU. Optionally, F1 setup request message includes gNB ID of source IAB donor.

In Step 14a, the target donor CU sends UE context setup request message to migrating IAB node. In an embodiment, the UE context setup request message includes one or multiple gNB-DU UE F1AP IDs. And then migrating IAB node sends F1AP UE context setup response message to target donor CU. Optionally, UE context setup request message includes indication info. The indication info includes at least one of the following: (a) source F1AP UE context release indication, or (b) CU change indication, or (c) Inter donor migration indication. In an embodiment, the migrating IAB node releases corresponding UE context associated with source donor CU after receiving the indication info.

Step 14b can be performed instead of Step 14a. In Step 14b, the target donor CU sends UE context modification request message to migrating IAB node. UE context modification request message includes one or multiple gNB-DU UE F1AP IDs. And then migrating IAB node sends F1AP UE context modification response message to target donor CU. Optionally, UE context modification request message includes indication info. The indication info includes at least one of the following: (a) source F1AP UE context release indication, or (b) CU change indication, or (c) 6) Inter donor migration indication.

In Step 15, a F1 setup procedure is performed for migrating IAB node’s descendant node. And UE context setup or modification procedure is performed for migrating IAB node’s descendant node.

In Step 16, the UE/migrating IAB node/child IAB node’s UE context in the source donor CU is released. And routing/traffic mapping/BH RLC channel configurations are released or reconfigured in the source path.

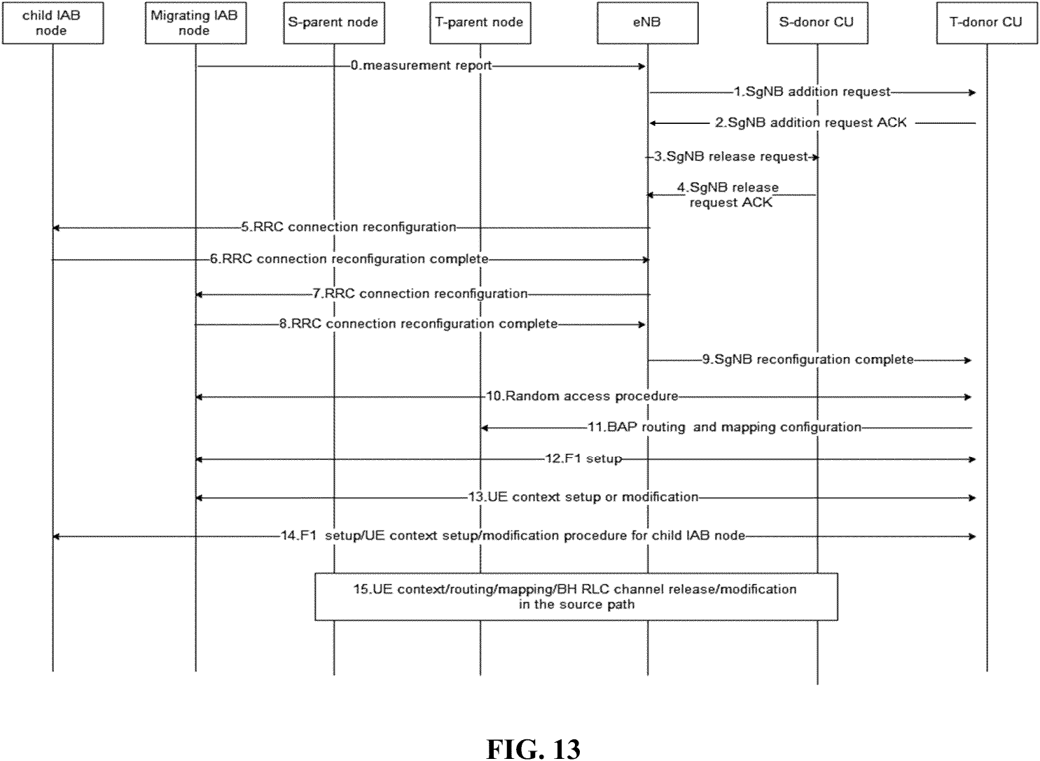

FIG. 13 illustrates the migration of a topology like one illustrated in FIG. 11.

Step 0 is optional. In Step 0 the migrating IAB node sends measurement report to the eNB.

In Step 1, the eNB initiates the SN change procedure by sending SgNB addition request message to the target donor CU. The SgNB addition request message includes at least one of the following: (a) group mobility interest, or group mobility indication, or mobile IAB node indication, or IAB node indication, or group mobility authorized information, or (b) UE context information for multiple UEs or IAB-MTs, or (c) BAP address of IAB node allocated by source donor CU, or (d) BH RLC channel configuration for IAB-MT configured by source donor CU, or (e) BH RLC channel configuration for collocated IAB-DU configured by source donor CU, including one of following: BH RLC channel ID, QoS, CP traffic type, RLC mode, etc., or (f) configuration information of collocated IAB-DU, including one of the following: (i) IP address request information, including one of the following IP address request, IPv4 address request number, IPv6 address request number, IPv6 address prefix request, etc., or (ii) DU ID, or (iii) updated DU Served Cell information, including PCI, CGI, PLMN ID list, etc., or (g) Routing configuration for the collocated IAB-DU configured by source donor CU, or (h) Traffic mapping configuration for the collocated IAB-DU configured by source donor CU, or (i) BAP routing ID and BAP addresses of IAB nodes along the corresponding path configured by source donor CU, or (j) Path ID and BAP addresses of IAB nodes along the corresponding path configured by source donor CU, or (k) gNB-DU UE F1AP ID, or (1) identity of DU which serves the UE/IAB-MT, e.g. BAP address, DU ID and/or gNB ID of source donor CU.

In Step 2, target donor CU sends SgNB addition request ACK message to the eNB. The SgNB addition request ACK message includes at least one of the following: (a) group mobility indication, or (b) RRC reconfiguration messages for multiple UEs or IAB-MTs, or (c) Collocated IAB-DU configuration info, including one of the following: (i) IP address information allocated for IAB-DU, including one of the following: IP address, IP address prefix, IP address usage, IAB donor DU BAP address, or (ii) target donor CU’s IP address, or (iii) reconfigured DU ID for the collocated IAB-DU, or (iv) updated DU Served Cell information, including PCI, CGI, PLMN ID list, etc.

Step 3 is optional. In Step 3, the eNB sends SgNB release request message to the source donor CU.

Step 4 is optional. In Step 4, the source donor CU sends SgNB release request ACK message to the eNB.

In Steps 5-8, eNB sends RRC connection reconfiguration message including the new configuration to child/migrating IAB nodes and UEs. The IAB node or UE applies the new configuration and sends the RRCConnectionReconfigurationComplete message to the eNB.

In Step 9, if the RRC connection reconfiguration procedure was successful, the eNB informs the target donor CU via SgNB Reconfiguration Complete message.

In Step 10, the migrating IAB nodes performs random access procedure with the target parent node or target donor CU.

In Step 11, target donor CU configures at least one of BH RLC channels or BAP-sublayer routing entries on the target path between the target parent IAB-node and target IAB-donor-DU or UL traffic mapping for the target path or DL mappings on the target IAB-donor-DU. These configurations may be performed at an earlier stage, e.g. immediately after step 4.

In Step 12, the migrating IAB node initiates F1 setup procedure with the target donor CU using the IP address received via RRC. Migrating IAB node sends F1 setup request message to target donor CU. Optionally, F1 setup request message includes gNB ID of source IAB donor.

In Step 13a, the target donor CU sends UE context setup request message to migrating IAB node. UE context setup request message includes one or multiple gNB-DU UE F1AP IDs. And then migrating IAB node sends F1AP UE context setup response message to target donor CU. Optionally, UE context setup request message includes indication info. The indication info includes at least one of the following: (a) source F1AP UE context release indication, or (b) CU change indication, or (c) Inter donor migration indication. In an embodiment, the migrating IAB node may release corresponding UE context associated with source donor CU after receiving the indication info

Step 13b can be performed instead of step 13a. In Step 13, target donor CU sends UE context modification request message to migrating IAB node. UE context modification request message includes one or multiple gNB-DU UE F1AP IDs. And then migrating IAB node sends F1AP UE context modification response message to target donor CU. Optionally, UE context modification request message includes indication info. The indication info includes at least one of the following: (a) source F1AP UE context release indication, or (b) CU change indication, or (c) inter donor migration indication.

In Step 14, F1 setup procedure is performed for migrating IAB node’s descendant node, and UE context setup or modification procedure is performed for migrating IAB node’s descendant node

In Step 15, the UE/migrating IAB node/child IAB node’s UE context in the source donor CU is released. And routing/traffic mapping/BH RLC channel configurations are released or reconfigured in the source path.

It should be understood that the steps disclosed herein are illustrative and are not necessarily intended to be performed in the exact order recited. Further, it is not intended that each step is necessary. A step may be optionally excluded, or replaced with another mechanism.

It should be understood that, while some embodiments describe the transmission of certain data to a node in the IAB deployment, that the disclosure envisions the receipt and further transmission. For instance, where an IAB node is described as transmitting a piece of data intended for a UE, it should be understood that any number of child IAB nodes exist in between the IAB node transmitting the data and the UE. It should be understood that those IAB nodes likewise transmit that data. The same applies for any nodes in between the path of an IAB node transmitting data and the IAB donor CU.

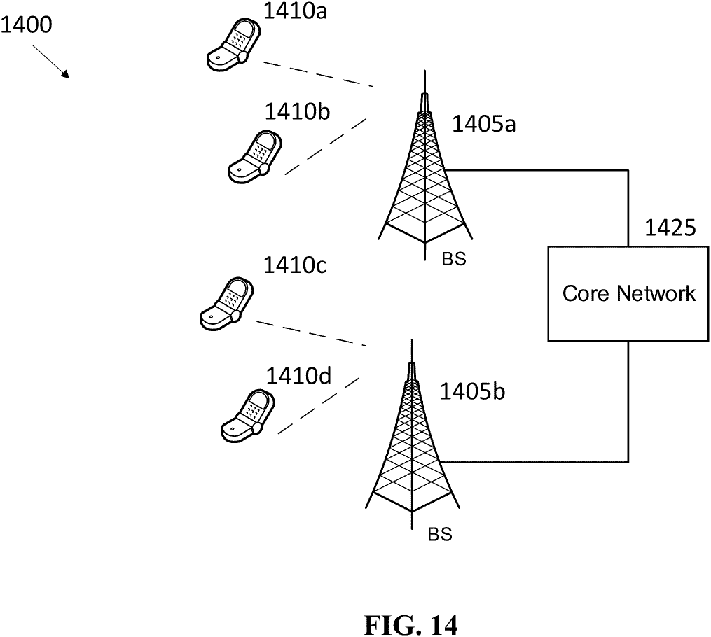

FIG. 14 shows an example of a wireless communication system 1400 where techniques in accordance with one or more embodiments of the present technology can be applied. A wireless communication system 1400 can include one or more base stations (BSs) 1405a, 1405b, one or more wireless devices 1410a, 1410b, 1410c, 1410d, and a core network 1425. A base station 1405a, 1405b can provide wireless service to wireless devices 1410a, 1410b, 1410c and 1410d in one or more wireless sectors. In some implementations, a base station 1405a, 1405b includes directional antennas to produce two or more directional beams to provide wireless coverage in different sectors. As should be understood, with reference to FIGS. 1 to 3, the base stations can be a series of IAB nodes.

The core network 1425 can communicate with one or more base stations 1405a, 1405b. The core network 1425 provides connectivity with other wireless communication systems and wired communication systems. The core network may include one or more service subscription databases to store information related to the subscribed wireless devices 1410a, 1410b, 1410c, and 1410d. A first base station 1405a can provide wireless service based on a first radio access technology, whereas a second base station 1405b can provide wireless service based on a second radio access technology. The base stations 1405a and 1405b may be co-located or may be separately installed in the field according to the deployment scenario. The wireless devices 1410a, 1410b, 1410c, and 1410d can support multiple different radio access technologies. The techniques and embodiments described in the present document may be implemented by the base stations of wireless devices described in the present document.

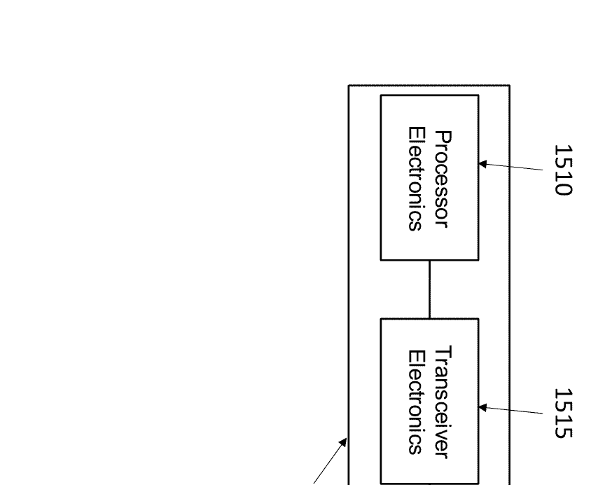

FIG. 15 is a block diagram representation of a portion of a radio station in accordance with one or more embodiments of the present technology can be applied. A radio station 1505 such as a base station or a wireless device (or UE) or MT can include processor electronics 1510 such as a microprocessor that implements one or more of the wireless techniques presented in this document. The radio station 1505 can include transceiver electronics 1515 to send and/or receive wireless signals over one or more communication interfaces such as antenna 1520. The radio station 1505 can include other communication interfaces for transmitting and receiving data. Radio station 1505 can include one or more memories (not explicitly shown) configured to store information such as data and/or instructions. In some implementations, the processor electronics 1510 can include at least a portion of the transceiver electronics 1515. In some embodiments, at least some of the disclosed techniques, modules or functions are implemented using the radio station 1505. In some embodiments, the radio station 1505 may be configured to perform the methods described herein.

It will be appreciated that the present document discloses techniques that can be embodied in various embodiments of IAB deployments. The disclosed and other embodiments, modules and the functional operations described in this document can be implemented in digital electronic circuitry, or in computer software, firmware, or hardware, including the structures disclosed in this document and their structural equivalents, or in combinations of one or more of them. The disclosed and other embodiments can be implemented as one or more computer program products, i.e., one or more modules of computer program instructions encoded on a computer readable medium for execution by, or to control the operation of, data processing apparatus. The computer readable medium can be a machine-readable storage device, a machine-readable storage substrate, a memory device, a composition of matter effecting a machine-readable propagated signal, or a combination of one or more them. The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them. A propagated signal is an artificially generated signal, e.g., a machine-generated electrical, optical, or electromagnetic signal, that is generated to encode information for transmission to suitable receiver apparatus.

A computer program (also known as a program, software, software application, script, or code) can be written in any form of programming language, including compiled or interpreted languages, and it can be deployed in any form, including as a stand-alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this document can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random-access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

While this patent document contains many specifics, these should not be construed as limitations on the scope of any invention or of what may be claimed, but rather as descriptions of features that may be specific to particular embodiments of particular inventions. Certain features that are described in this patent document in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Moreover, the separation of various system components in the embodiments described in this patent document should not be understood as requiring such separation in all embodiments.

Only a few implementations and examples are described, and other implementations, enhancements and variations can be made based on what is described and illustrated in this patent document.

What is claimed is:

1. An information transmission method comprising:
receiving, at a network node, a measurement threshold via a Radio Resource control (RRC) message sent from an IAB donor Centralized Unit (CU);
performing, at the network node, measurement of a serving cell, wherein if a measured result is lower than the measurement threshold, the network node sends mobility configuration to a child node or a wireless device, or the network node sends mobility assistance information to the IAB donor CU.

2. The method according to claim 1, wherein the measurement threshold is a Reference Signal Received Power (RSRP) threshold based on a synchronization signals (SS)/physical broadcast channel (PBCH) block or based on a Channel State Information Reference Signal (CSI-RS).

3. The method according to claim 1, wherein the mobility configuration information comprises (a) indication information relating to whether a parent network node is performing or will perform inter-CU migration, or (b) indication information relating to whether an ancestor node is performing or will perform inter-CU migration, or (c) indication information relating to starting measuring, or (d) measurement configuration.

4. The method according to claim 1, wherein the mobility assistance information comprises:
(a) measurement results, or (b) a group mobility indication, or (c) a group mobility interest, or (d) a group mobility intention, or (e) a mobility type, or (f) information regarding a target cell, or (g) information regarding a candidate cell.

5. An information transmission method comprising:
sending, at a first base station, a mobility related request message to a second base station, wherein the base station is an eNB or a donor Centralized Unit (CU) or a gNB;
receiving at the first base station, a mobility related ACK message from the second base station.

6. The method according to claim 5 further comprising: before sending the mobility related request message to a second base station, receiving a mobility related required message from a third base station, wherein the base station is a eNB or donor CU or a gNB.

7. The method according to claim 5, wherein the mobility related request message is a handover request message, or a SgNB addition request message.

8. The method according to claim 5, wherein the mobility related ACK message is a handover request acknowledge message, or a SgNB addition request acknowledge message.

9. The method according to claim 6, wherein the mobility related required message is a SgNB change required message.

10. The method according to claim 5, further comprising: configuring, at the donor CU, (a) BH RLC channels, or (b) BAP-sublayer routing entries for a target path, or (c) UL traffic mapping for the target path, or (d) DL mappings on a target integrated access and backhaul (IAB) donor Distributed Unit (DU).

11. The method according to claim 5, wherein the mobility related request or mobility related required message comprises: a group mobility interest, or a group mobility indication, or a mobile IAB node indication, or an IAB node indication, or information relating to a group mobility authorisation, or User Equipment (UE) context information for one or multiple UEs or IAB-Mobile Terminals(MTs), or a BAP address of the IAB node allocated by a source donor CU, or a Backhaul (BH) radio link control (RLC) channel configuration for an IAB-MT configured by the source donor CU, or a BH RLC Channel configuration for a collocated IAB-DU configured by the source donor CU including a BH RLC Channel ID or a QoS or a CP traffic type or an RLC mode, or configuration information of collocated IAB-DU, or routing configuration for the collocated IAB-DU configured by the source donor CU, or traffic mapping configuration for a collated IAB-DU configured by the source donor CU, or BAP routing ID and BAP addresses of IAB nodes along a corresponding path configured by the source donor CU, or a Path ID and BAP addresses of IAB nodes along a corresponding path configured by the source donor CU, or a gNB-DU UE F1AP ID, or a PDCP information, or an identity of DU which serves a UE/IAB-MT including its BAP address, or its DU ID, and/or the gNB ID of source donor CU.

12. The method according to claim 11, wherein the configuration information of collocated IAB-DU comprises: an IP address request information including an IP address request or an IPV4 address request number or an IPv6 address request number or an IPv6 prefix request, or a DU ID, or a DU served cell information including a PCI or a CGI or a PLMN ID list.

13. The method according to claim 5, wherein the mobility related ACK message comprises: a group mobility indication, or RRCreconfiguration message(s) for one or multiple UEs or IAB-MTs, or a collocated IAB-DU configuration information, or a routing configuration information configured by the second base station, or a traffic mapping configuration information configured by the second base station, or a indication information which indicates that the routing configuration information or the traffic mapping configuration information is applicable on a target path.

14. The method according to claim 11, wherein the collocated IAB-DU configuration information comprises: IP address information allocated for the IAB-DU comprising an IP address, or an IP address prefix, or an IP address usage, or an IAB donor DU BAP address, or a target donor CU’s IP address, or reconfigured DU ID for the collocated IAB-DU, or updated DU Served Cell information, including a PCI or a CGI or a PLMN ID list.

15. The method according to claim 5, further comprising: after receiving the mobility related request message from a first base station, receiving, at the second base station, a F1 setup request message from a IAB node, wherein the F1 setup message includes gNB ID of source IAB donor.

16. The method according to claim 5, wherein after receiving the mobility related request message from the first base station, sending, at the second base station, a F1AP message to a IAB node, wherein the message includes multiple gNB-DU UE F1AP IDs, or UL UP TNL Information, or New UL UP TNL Information, or BH Information, or Old TNL Address of gNB-CU, or New TNL Address of gNB-CU, or a source F1AP UE context release indication, or a CU change indication, or a inter donor migration indication, wherein the F1AP message is a UE context setup request message, or a UE context modification request message, or a IAB UP configuration update request message, or a new F1AP message.

17. The method according to claim 5, wherein after sending the mobility related ACK message to the first base station, sending, at the second base station, a UE context release message to the first base station, wherein the UE context release message includes multiple pairs of source/target NG-RAN node UE XnAP IDs, or multiple pairs of old and new eNB UE X2AP IDs, wherein after receiving the mobility related ACK message from the second base station, sending, at the first base station, a message to the second base station, wherein the message includes SN status information for multiple UEs/IAB-MTs, or multiple pairs of source and target NG-RAN node UE XnAP IDs, or multiple pairs of old and new eNB UE X2AP IDs.

18. An information transmission method comprising:
receiving, at a target network node, Packet Data Convergence Protocol (PDCP) information; and
performing, at the target network node, (a) deciphering using the received PDCP information, or (b) header decompression using a received PDC information, or (c) integrity verification using the received PDCP information.

19. The method according to claim 18, wherein before receiving the PDCP information, transmitting, at the target network node, PDCP configuration request information to a source network node, wherein the PDCP configuration request information includes a PDCP key request indication or a PDCP key indication.

20. The method according to claim 18, wherein the PDCP information includes ciphering related info, or integrity related info, or a Hyper Frame Number (HFN), or Header Compression related information, wherein the ciphering related info includes ciphering key, or cipheringAlgorithm; wherein the integrity related info includes integrity key, or integrityProtAlgorithm.
